(19) United States
(12) Patent Application Publication
(10) Pub. No.: US 2015/0067165 A1
(43) Pub. Date: Mar. 5, 2015

(54) METHOD OF MANAGING POLICY FOR REDUCING NETWORK LOAD DUE TO DATA LIMIT

(71) Applicant: IDEAWARE INC., Seongnam-si, Gyeonggi-do (KR)

(72) Inventor: Yang Meong Cha, Seongnam-si (KR)

(73) Assignee: IDEAWARE INC., Seongnam-si, Gyeonggi-do (KR)

(21) Appl. No.: 14/389,750

(22) PCT Filed: Apr. 18, 2013
(86) PCT No.: PCT/KR2013/003302

§ 371 Date: Sep. 30, 2014

(30) Foreign Application Priority Data
Apr. 25, 2012 (KR) 10-2012-0043436

(51) Int. Cl. H04W 76/06; H04L 12/911; H04L 29/08

(52) U.S. Cl. CPC H04W 76/066; H04L 67/143; H04L 47/824
USPC 709/225

(57) ABSTRACT

The present invention relates to a method managing a policy for reducing network load due to data limit. The method comprises storing, in a policy server, identification information of the wireless terminal in connection with identification information of a policy agent equipped in the wireless terminal; checking, in the policy server, the identification information of the policy agent corresponding to the identification information of a user's wireless terminal whose data limit is exceeded by using the storage medium; processing, in the policy server, so that policy information for blocking network usage is transmitted to the checked policy agent, in case data limit of the wireless terminal is restored; blocking, in the policy agent, network connection of all applications except the applications corresponding to identification information predetermined to applications allowed the network usage among a plurality of applications using network, based on the policy information for blocking network usage; processing, in the policy server, so that policy information for releasing the network usage blocking is transmitted to the policy agent, in case data limit of the wireless terminal is restored; and releasing, in the policy agent, the blocking of network connection for the applications, based on the received policy information for releasing the network usage blocking.

### BACKGROUND OF THE INVENTION

1. Technical Field

The present invention is to reduce wireless network load by autonomously controlling network connection of the applications for wireless terminal exceeding data limit.

2. Description of the Related Art

After supplying smart-phones, patterns using wireless terminal for individuals are abruptly changed from voice communication to data communication.

In FIG. 1 shown as mobile (wireless) data traffic index, mobile traffics are expected to increase to 26 times in the next 10 to 15 years, and mobile data amount of 15 MB used by individuals per day has been used in 2010 but mobile data amount of 1 GB will be used in 2020.

The increase of the mobile traffics directly effects on profitability and service quality of the mobile-service company and accompanies a service provider, that is, a mobile-service company's equipment expansion, and therefore profit aggravation is inevitable and a user using a mobile network has service dissatisfaction due to data communication velocity delay.

Therefore, the mobile-service company must effectively use network infra to reduce investment burden and to guarantee service quality and an alternative guaranteeing predictability and real-time control is needed due to the limits of current solutions.

On the other hand, FIG. 2 shows that numerous applications at the wireless terminal exceeding data limit cause network connection traffics irrespective of exceeding of the data limit.

Particularly, in the situation such as FIG. 2, the applications installed in the wireless terminal endlessly request the network connection traffics to receive data to be wanted because the wireless terminal may not receive data on connecting to application servers even on attempting the network connection on the condition exceeding the data limit already, and the network connection request causes overload in the communication network.

In order to solve much cost consumption of the mobile communication company due to network jam and service dissatisfaction for users of the wireless terminal, a method for blocking periodic network usage by a plurality of applications installed in the wireless terminal is absolutely needed, but there is no a solution for this.

### SUMMARY OF THE INVENTION

An object of the present invention for solving the above-mentioned problems is that it provides method for controlling unnecessary network connection trial itself performed by the applications installed in the wireless terminal that may not connect to application servers and receive data even on attempting the network connection on the condition exceeding the data limit already, and improving data communication environment of the user and reducing battery consumption by network jam removal while reducing network expansion cost of a mobile communication company and improving service quality. To achieve this, a policy server stores identification information of a wireless terminal in connection with identification information of a policy agent equipped in the wireless terminal into a storage medium, checks the identification information of a policy agent corresponding to the identification information of the wireless terminal exceeding data limit by using the storage medium, and processes so that policy information for blocking network usage is transmitted to the checked policy agent. And, the policy agent blocks network connection of all applications except one or more applications corresponding to identification information predetermined to applications allowed the network usage among a plurality of applications using network, based on the policy information for blocking network usage. Also, in case data limit of the wireless terminal exceeding data limit is restored, the policy server processes so that policy information for releasing the network usage blocking is transmitted to the policy agent, and the policy agent releases network connection blocking of the applications, based on policy information for releasing the network usage blocking.

Another object of the present invention for solving the above-mentioned problems is that it provides method for controlling unnecessary network connection trial itself performed by the applications installed in the wireless terminal that may not connect to application servers and receive data even on attempting the network connection on the condition exceeding the data limit already, and improving data communication environment of the user and reducing battery consumption by network jam removal while reducing network expansion cost of a mobile communication company and improving service quality. To achieve this, a policy server stores identification information of a wireless terminal in connection with identification information of a policy agent equipped in the wireless terminal into a storage medium, checks the identification information of a policy agent corresponding to the identification information of the wireless terminal exceeding data limit by using the storage medium, and processed so that policy information for blocking network usage is transmitted to the checked policy agent. And, the policy agent blocks network connection of all applications except applications corresponding to identification information predetermined to applications allowed the network usage among a plurality of applications using network, based on the policy information for blocking network usage. Also, the policy agent checks the day and time when the data limit is restored after exceeding the data limit by checking the current day and time information. And, in case the restoring day and time corresponds to the current day and time according to a result of the checking, the policy agent releases network connection blocking of the applications.

Technical tasks to achieve in the present invention are not limited to the above-mentioned technical tasks. Other technical tasks which are not mentioned may be clearly understandable for those who skilled in the art of the present invention from the following description.

A method managing a policy for reducing network load due to data limit, according to an embodiment of the present invention, comprising: storing, in a policy server, identification information of the wireless terminal in connection with identification information of a policy agent equipped in the wireless terminal; checking, in the policy server, the identification information of the policy agent corresponding to the identification information of a user's wireless terminal whose data limit is exceeded by using the storage medium; processing, in the policy server, so that policy information for blocking network usage is transmitted to the checked policy agent, in case data limit of the wireless terminal is restored; blocking, in the policy agent, network connection of all applications except applications corresponding to identification information predetermined to applications allowed the network usage among a plurality of applications using network, based on the policy information for blocking network usage; processing, in the policy server, so that policy information for releasing the network usage blocking is transmitted to the policy agent, in case data limit of the wireless terminal is restored; and releasing, in the policy agent, the blocking of network connection for the applications, based on the received policy information for releasing the network usage blocking.

A method managing a policy for reducing network load due to data limit, according to another embodiment of the present invention, comprising: storing, in a policy server, identification information of the wireless terminal in connection with identification information of a policy agent equipped in the wireless terminal; checking, in the policy server, the identification information of the policy agent corresponding to the identification information of a user's wireless terminal whose data limit is exceeded by using the storage medium; processing, in the policy server, so that policy information for blocking network usage is transmitted to the checked policy agent, in case data limit of the wireless terminal is restored; blocking, in the policy agent, network connection of all applications except applications corresponding to identification information predetermined to applications allowed the network usage among a plurality of applications using network, based on the policy information for blocking network usage; checking, in the policy agent, the day and time when the data limit is restored after exceeding the data limit by checking the current day and time information; and releasing, in the policy agent, the blocking of network connection for the applications, in case the current day and time corresponds to the restoring day and time according to a result of the checking.

According to an aspect of the invention, the method managing a policy for reducing network load due to data limit, further comprising: processing, in the policy server, so that identification information on the applications allowed the network usage irrespective of data limit is transmitted to the policy agent; and storing, in the policy agent, identification information on the applications allowed the network usage irrespective of data limit into a storage region.

According to an embodiment of the present invention, the present invention may block unnecessary network connection attempts itself performed by the applications installed in the wireless terminal that may not receive data after connecting to the application servers even on attempting the network connection on the condition exceeding the data limit already.

According to another embodiment of the present invention, the present invention may block unnecessary network connection attempts itself performed by the applications installed in the wireless terminal, thereby to optimize network usage at wireless terminal stages.

According to further another embodiment of the present invention, mobile-service company's network expansion cost may be minimized by optimizing the network usage.

According to further yet another embodiment of the present invention, on optimizing network usage, it is possible to minimize dissatisfaction for the wireless terminal's user caused by data communication delay, etc. and to greatly reduce battery consumption for the wireless terminal.

### BRIEF DESCRIPTION OF THE DRAWINGS

The following drawing drawings attached to the present specification illustrate an exemplary embodiment of the invention, and serves to further understand the technical idea of the invention along with a detailed description of the invention. Therefore, the invention is not limited to matters described in the drawings.

FIG. 1 shows mobile (wireless) data traffic indexes.

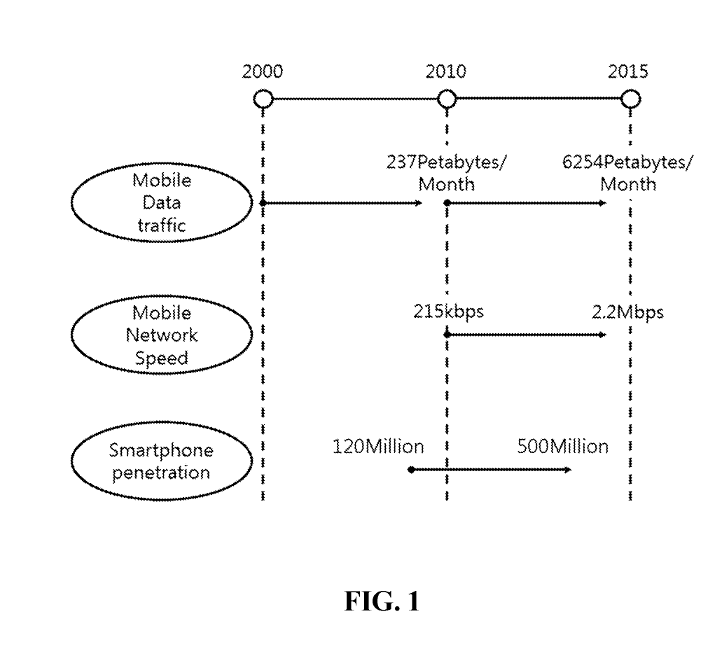

FIG. 2 shows main factors that may cause prior mobile network jam.

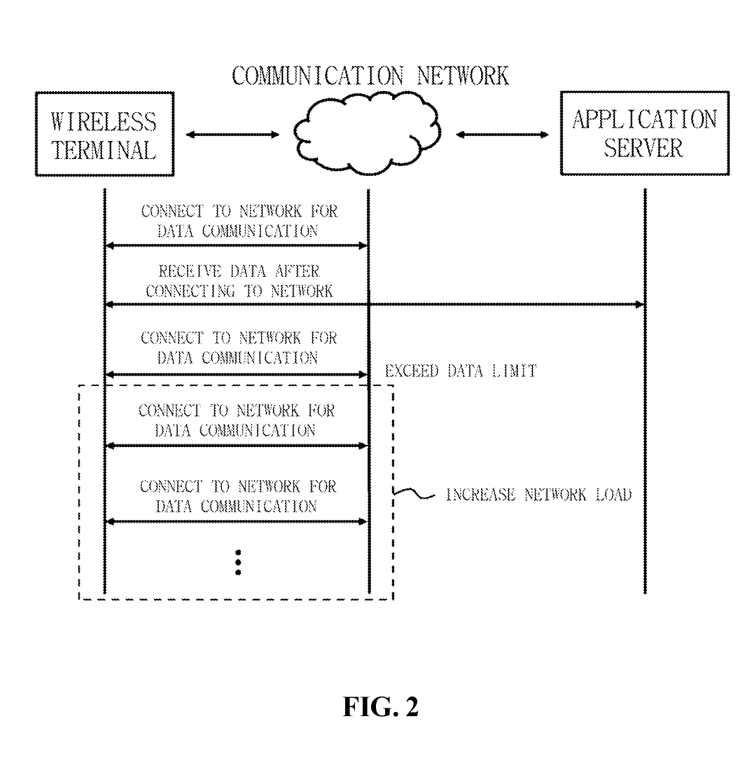

FIG. 3 shows communication network or network connection according to an embodiment of the present invention.

FIG. 4 shows sub-configurations for a policy server according to the embodiment of the present invention.

FIG. 5 shows sub-configurations for a wireless terminal according to the embodiment of the present invention.

FIG. 6 is one embodiment showing effects blocking network connection of the wireless terminal exceeding data limit according to an embodiment of the present invention.

FIG. 7 shows a process blocking network connection of the wireless terminal that exceeds the data limit according to the embodiment of the present invention.

FIG. 8 shows a process blocking network connection of the wireless terminal that exceeds the data limit by using a policy agent according to the embodiment of the present invention.

FIG. 9 shows a process releasing network connection blocking of the wireless terminal restoring the data limit according to the embodiment of the present invention.

FIG. 10 shows a process releasing network connection blocking of the wireless terminal restoring the data limit by using a policy agent according to the embodiment of the present invention.

FIG. 11 shows a process releasing network connection blocking of the wireless terminal restoring the data limit by using a policy agent according to another embodiment of the present invention.

### DESCRIPTION OF THE PREFERRED EMBODIMENTS

Hereinafter, referring to enclosed figures and descriptions, operation principles of preferred embodiments of the present invention will be described. However, figures illustrated and descriptions mentioned in the below are only for the preferred embodiments among various method of describing features of the present invention. Therefore, the present invention is not limited to the figures illustrated and descriptions mentioned in the below. Additionally, in case of determining that a detailed description about known function or structure relating to the present invention may evade the main point of the present invention, the detailed description may be omitted. Also, terms to be mentioned in the following are defined in consideration of functions in the present invention, which may be vary according to the intention of a user or an operator, practical customs, etc. Therefore, the definition of the terms shall be made based on the overall contents of the present invention.

In conclusion, the technical spirit of the present invention shall be decided by claims. The following embodiments are merely a means for describing progressive spirit of the present invention to persons who skilled in the art of the present invention.

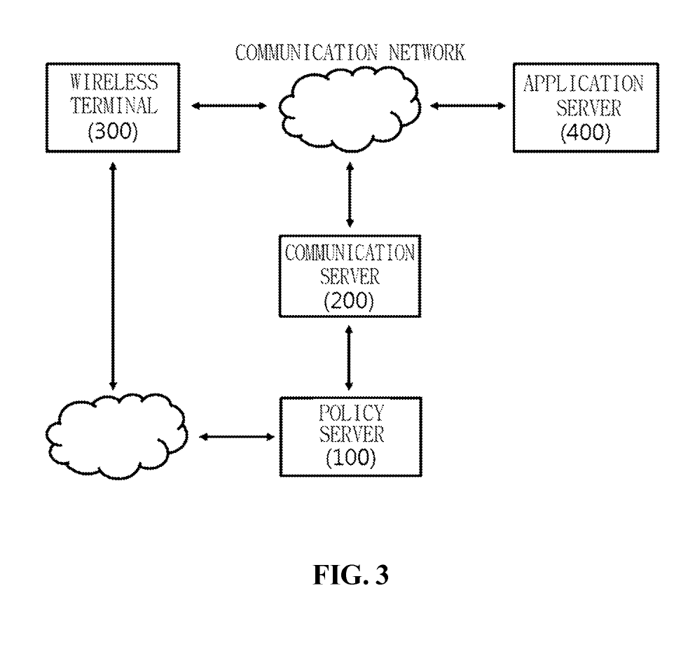

FIG. 3 shows communication networks or network connections according to an embodiment of the present invention.

In more detail, FIG. 3 shows configurations that a system of managing the policy for reducing network load, the system including a policy server 100, is connected to a communication server 200 and a wireless terminal 300 through the communication networks or networks to control network connection of applications for the wireless terminal 300 exceeding the data limit.

The system for managing network load reduction policy, according to the present invention, may have various configuration according to implement method and connection method of the communication network.

For example, the policy server 100 may be connected to the communication server 200 through the communication networks or networks, or directly connected to the communication server 200, or included in the communication server 200.

The policy server 100, that is a core element of the system for managing network load reduction policy according to the present invention, checks identification information of policy agent installed in the wireless terminal 300 in response to identification information of the user's wireless terminal 300 exceeding the data limit through a storage medium 130 connecting and storing identification information of the wireless terminal 300 and identification information of policy agent installed in the wireless terminal 300, and transmits policy information for blocking network usage to policy agent corresponding to the identification information of the checked policy agent, on receiving identification information of the user's wireless terminal 300 exceeding the data limit from a communication server 200 on a communication network.

The policy information for blocking the network usage includes the policy information for blocking network connection for all applications except pre-designated specific applications among a plurality of applications using networks in the wireless terminal 300.

According to the present invention, the policy server 100 receives the identification information of the wireless terminal 300 whose data limit is restored from the communication server 200 on the communication network, checks the identification information of the policy agent installed in the wireless terminal 300 in response to the received identification information of the wireless terminal 300 through the storage medium 130, transmits policy information for releasing network usage blocking to the policy agent corresponding to the checked identification information of the policy agent, and transmits the identification information of the applications for which network usage is allowed irrespective of exceeding of data limit to the policy agent.

The communication server 200 in the embodiment of the present invention relays data communication between the wireless terminal 300 and an application server, checks whether the wireless terminal 300 exceeds the data limit, and transmits the identification information of the wireless terminal 300 exceeding the data limit to the policy server 100 in case of exceeding the data limit after the checking.

According to the present invention, the communication server 200 checks exceeding of the data limit by an intelligence network, and then checks causes of exceeding the data limit by using a subscriber information server (a server for storing and managing IMEI information, information of a subscriber's terminal, subscription/cancellation information for a payment system, etc. of the wireless terminal 300).

Further, the communication server 200 checks whether the data limit of the wireless terminal 300 is restored by using the subscriber information server, and then transmits the identification information of the wireless terminal 300 whose data limit is restored to the policy server 100 in case of restoring the data limit after the checking.

The subscriber information server may be included in the communication server 200.

The wireless terminal 300 according to the embodiment of the present invention performs the network connection to the application server, and autonomously controls the network connection (or background connection, etc.) of a plurality of applications installed in the wireless terminal 300 by the policy information, for blocking the network usage, and the policy information, for releasing the network usage blocking, received from the policy server 100.

Also, the wireless terminal 300 in advance stores the identification information of the applications for which network usage is allowed irrespective of limit of data into a storage region 330, and excludes the applications corresponding to the identification information of the applications allowed the network usage, pre-stored in the storage region 330, among the plurality of applications using networks on performing the policy information, for blocking the network usage, received from the policy server 100 according to exceeding of the data limit.

Also, after blocking all but the applications corresponding to the identification information of the applications allowed the network usage, pre-stored in the storage region 330, among the applications using networks based on the policy information for blocking network usage, the wireless terminal 300 checks restoration day and time for the data limit after exceeding the data limit by checking the current day and time. And, the wireless terminal 300 releases the network connection blocking for the applications in case the current day and time corresponds to the restoration day and time for the data limit, so further performs a role of automatically releasing the network connection blocking for the applications installed in the wireless terminal 300 without communication with a server.

According to the present invention, the wireless terminal 300 include all terminal, capable of wirelessly communicating, such as a mobile phone, a smart-phone, a tablet PC, etc.

The application server 400 in the present invention transmits and receives data on performing the network connection for the applications installed in the user's wireless terminal 300.

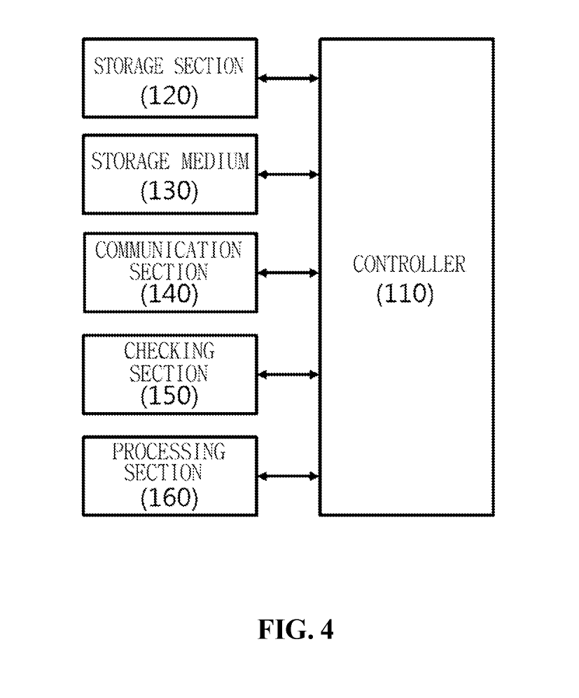

FIG. 4 shows sub-configurations of the policy server 100 according to an embodiment of the present invention.

In more detail, FIG. 4 shows sub-configurations for the policy server 100 in the system for managing network load reduction policy shown in FIG. 3, each configuration is to describe an embodiment of the present invention, and the present invention is not limited to the embodiment only shown in FIG. 4.

Referring to FIG. 4, the policy server 100 according to the embodiment of the present invention includes a storage section 120, a storage medium 130, a communication section 140, a checking section 150, a processing section 160, and a controller 110 for controlling each configuration.

Here, though the policy server 100 is shown as a single server in the drawing for a description of an example, may be composed of one or more separated servers for the each mean or component.

Referring to FIG. 4, the storage section 120 stores identification information of a plurality of wireless terminals 300 in connection with identification information of the policy agent in each of the wireless terminals 300, in the storage medium 130.

According to the present invention, the storage section 120 further stores various information and data that are transmitted and received with the communication server 200 and the user's wireless terminal 600 in the storage medium 130 or a database, besides the identification information of the wireless terminal 300 and the identification information of the policy agent.

Here, the identification information of the wireless terminal 300 may include at least one of a serial number of the wireless terminal 300 and identification information of a subscriber (or a user) of the wireless terminal 300, and the identification information of the policy agent may include unique ID or number of the agent.

The storage medium 130 according to the present invention stores and manages the identification information of a plurality of wireless terminals 300 in connection with the identification information of the policy agent in each of the wireless terminals 300.

According to the present invention, the storage medium 130 may be included in another server other than the policy server 100, or in the communication server 200.

The communication section 140 according to the present invention receives identification information of a user's wireless terminal 300 whose data limit is exceeded from the communication server 200 over the communication network.

Also, the communication section 140 transmits and receives various information and data with the communication server 200 and the user's wireless terminal 300.

For example, the communication section 140 may further receive identification information of a user's wireless terminal 300 whose data limit is restored from the communication server 200 over the communication network, and transmit identification information of one or more applications allowed the network usage irrespective of the data limit to the policy agent included in the wireless terminal 300.

The checking section 150 according to an embodiment of the present invention checks the identification information of the policy agent corresponding to the identification information of the wireless terminal 300 whose data limit is exceeded, the policy agent being included in the wireless terminal 300, by using the storage medium 130.

According to the present invention, in case the communication section 140 receives the identification information of the wireless terminal 300 whose data limit is restored from the communication server 200 over the communication network, the checking section 150 may further check the identification information of the policy agent corresponding to the identification information of the wireless terminal 300 whose data limit is restored, the policy agent being included in the wireless terminal 300, by using the storage medium 130.

The processing section 160 according to the present invention processes so that the policy information for blocking network usage is transmitted to the policy agent corresponding to the identification information checked by the checking section 150.

Here, the policy information for blocking network usage includes policy information for blocking network connection of all applications except one or more predetermined applications among a plurality of applications installed in the wireless terminal 300.

Also, the processing section 160 processes so that the identification information of the application allowed the network usage irrespective of the data limit is transmitted to the policy agent. And, in case the data limit of the wireless terminal 300 whose data limit was exceeded is restored, the processing section 160 may further process so that policy information for releasing network usage blocking transmitted to the policy agent.

According to the present invention, a whole or a part of the functions of each component included in the policy server 100 may be implemented in a program or program set.

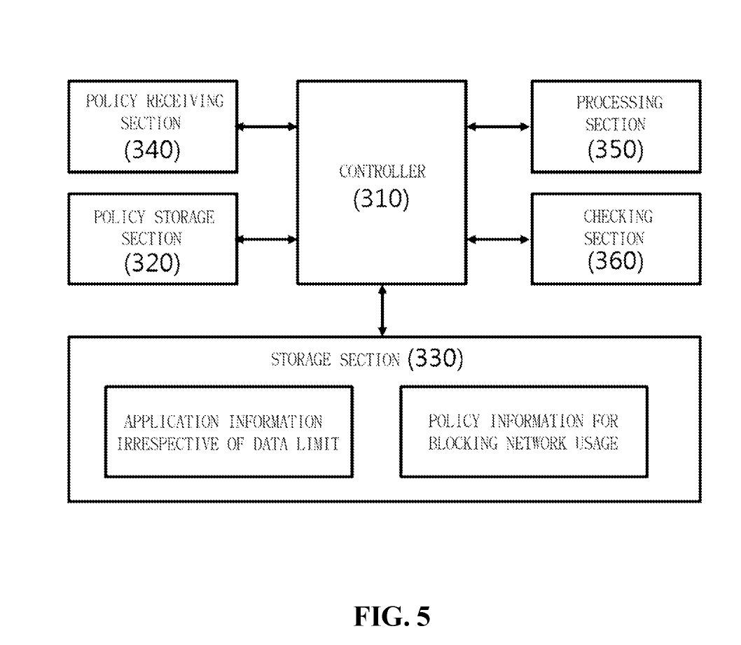

FIG. 5 shows sub-configurations of the wireless terminal 300 according to an embodiment of the present invention.

In more detail, FIG. 5 shows sub-configurations for the wireless terminal 300 shown in FIG. 3, each configuration is to describe an embodiment of the present invention, and the present invention is not limited to the embodiment only shown in FIG. 4.

Referring to FIG. 5, the wireless terminal 300 in the embodiment of the present invention includes a policy receipt section 340, a policy storage section 320, a policy storage region 330, a processing section 350, a checking section 360, and a controller 310 for controlling each configuration.

Wholly or in part of each configuration of the wireless terminal 300 may be configured in a program type such as policy agent.

Referring to FIG. 5, the policy receipt section 340 receives identification information of one or more applications allowed the network usage irrespective of the data limit from the policy server 100, and receives various information such as the policy information, for blocking the network usage, and the policy information, for releasing the network usage blocking, from the policy server 100.

The policy storage region 320 in the embodiment of the present invention stores the identification information of the applications allowed the network usage irrespective of the data limit into the storage region 330, the identification information being received by the policy receipt section 340.

The policy storage region 320 in the present invention stores the policy information for blocking the network usage and the policy information for releasing the network usage blocking, besides the identification information of the applications allowed the network usage irrespective of the data limit, into the storage region 330.

The storage region 330 in the embodiment of the present invention stores and manages the identification information of the applications allowed the network usage irrespective of the data limit.

Further, the storage region 330 stores the policy information for blocking the network usage and the policy information for releasing the network usage blocking, besides the identification information of the applications allowed the network usage irrespective of the data limit.

The processing section 350 in the embodiment of the present invention blocks the network connection for all applications except the applications corresponding to the identification information of the applications allowed the network usage, pre-stored in the storage region 330, among the applications using network based on the policy information for blocking the network usage received by the policy receipt section 340.

Further, the processing section 350 releases the network connection blocking for the applications based on the received policy information for blocking the network usage blocking on receiving the policy information for blocking the network usage blocking from the policy server 100 on the communication network by the policy receipt section 340.

The checking section 360 in the embodiment of the present invention checks the current day and time information and checks restoration day and time of the data limit after exceeding the data limit.

That is, when the data limit is re-granted on the first of the month, the checking section 360 checks whether the current day and time become 12 am on the first day of each month and checks whether it become the day and time for data restoration.

The processing section 350 in the present invention releases the network connection blocking for the applications installed in the wireless terminal 300, in the case that the current day and time is corresponded to the restoration day and time of the data limit, according to the result checked by the checking section 360.

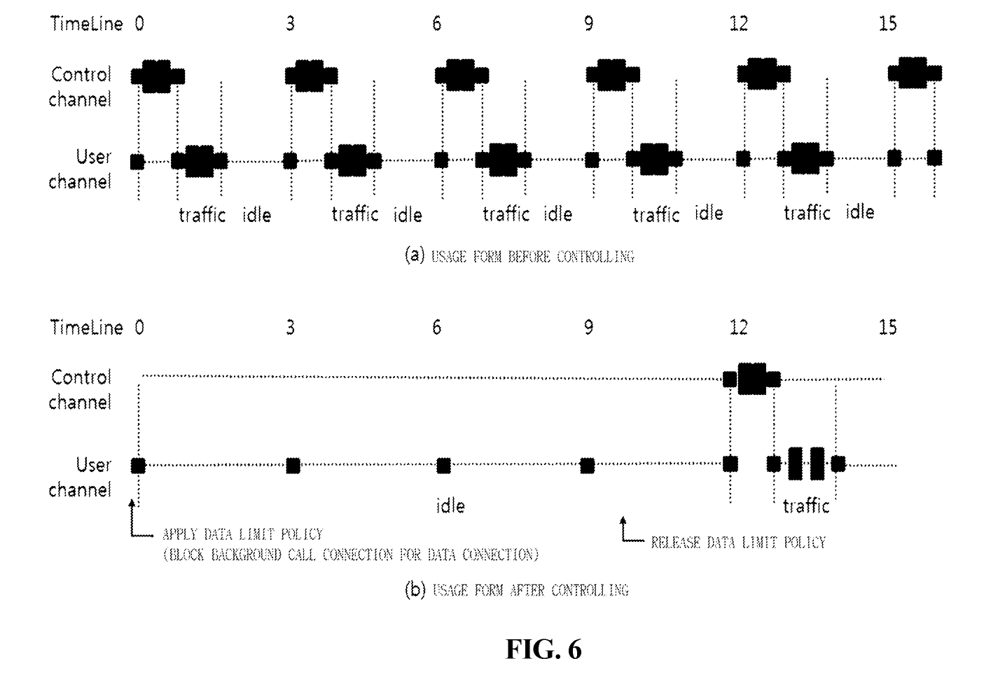

FIG. 6 is one embodiment showing effects generated by network connection blocking of wireless terminal 300 exceeding the data limit according to an embodiment of the present invention.

Referring to FIG. 6, a traffic reduction effect at the wireless terminal 300 before and after applying the policy is shown on performing the policy information (policy information, etc. for blocking background call connection for various applications) for blocking the network connection and releasing the network connection blocking to various applications installed in the wireless terminal 300 exceeding the data limit by the policy agent installed in the wireless terminal 300.

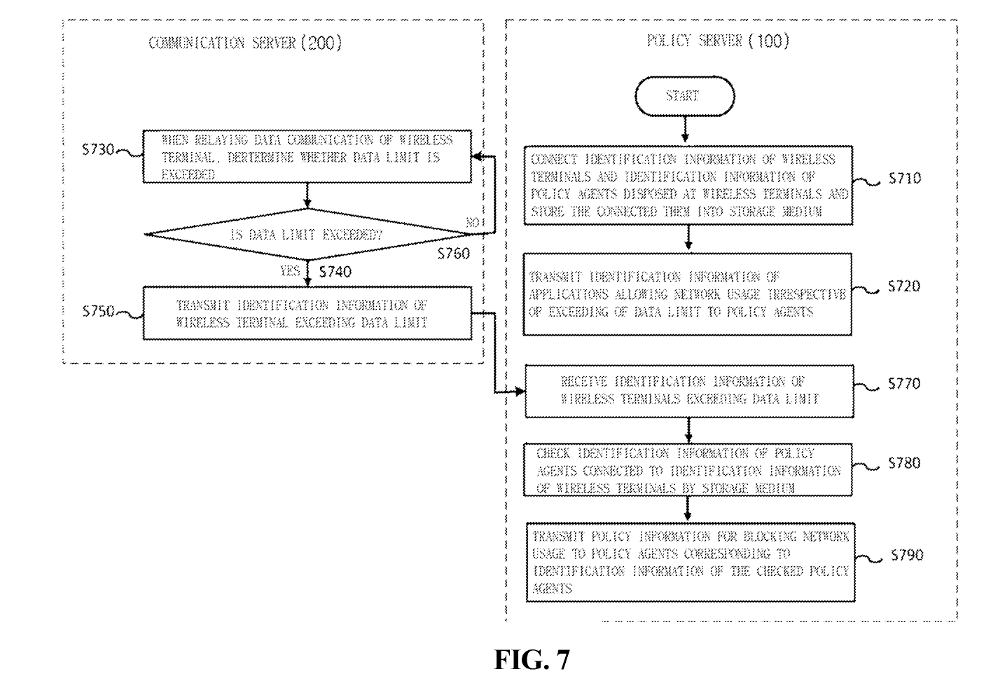

FIG. 7 shows a process for blocking the network connection for the wireless terminal 300 exceeding the data limit according to an embodiment of the present invention.

Firstly, the policy server 100 connects the identification information of a plurality of the wireless terminal 300 and the identification information of each policy agent installed in the plurality of wireless terminal 300 and therefore stores the connected information into the storage medium 130, by using the storage section 120(S710).

Then, the policy server 100 processes so that the identification information of the applications allowed the network usage irrespective of the exceeding of the data limit transmitted to the policy agent installed in the wireless terminal 300, and the policy agent stores the identification information of the applications allowed the network usage irrespective of the exceeding of data limit into the storage region, by using the processing section 160 (S720).

Orders for the steps S710 and S720 may be changed.

The communication server 200 according to the present invention determines whether data limit of the wireless terminal 300 is exceeded, when relaying data communication between the wireless terminal 300 and the application server 400 (S730).

In the step of S730, the communication server 200 may check exceeding of the data limit by an intelligence network, and then check causes of exceeding of the data limit by using the subscriber information server (a server for storing and managing IMEI information, information of a subscriber's terminal, subscription/cancellation information for a payment system, etc. of the wireless terminal 300).

In the step of S730, in case the data limit of the wireless terminal 300 requesting the network connection is exceeded (S740), the communication server 200 transmits identification information of the wireless terminal 300 exceeding data limit to the policy server 100 (S750).

In the step of S730, in case the data limit of the wireless terminal 300 requesting network connection is not exceeded (S760), the communication server 200 permits network connection for the wireless terminal 300.

The policy server 100 receives the identification information of the wireless terminal 300 whose data limit is exceeded from the communication server 200, by using the communication section 140 (S770).

Afterward, the checking section 150 of the policy server 100 checks identification information of the policy agent corresponding to the identification information of the wireless terminal 300 whose data limit is exceeded, by using the storage section 130 (S780).

Afterward, the policy server 100 processes so that the policy information for blocking network usage is transmitted to the policy agent corresponding to the identification information checked by the checking section 150, by using the processing section 160 (S790).

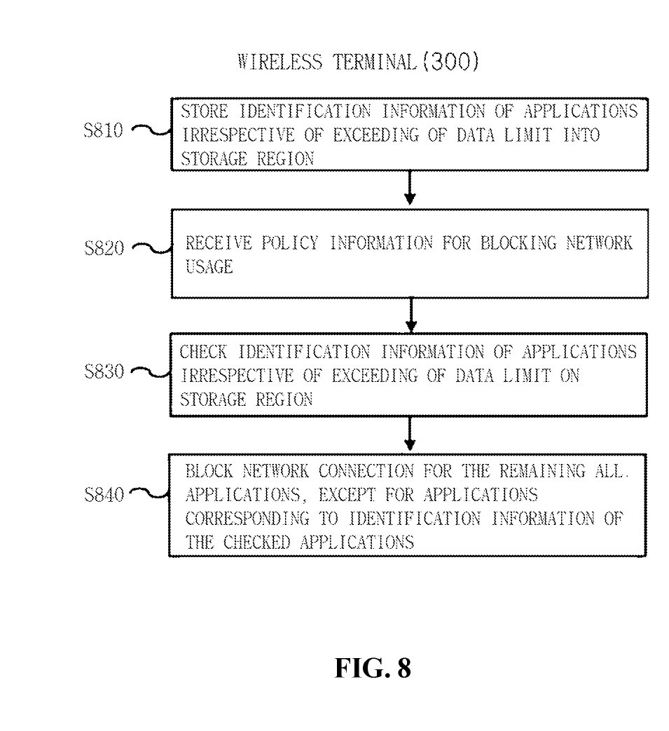

FIG. 8 shows a process for blocking the network connection for the wireless terminal 300 exceeding the data limit by using the policy agent according to an embodiment of the present invention.

Firstly, the policy agent of the wireless terminal 300 receives the identification information of the applications allowed the network usage irrespective of the data limit, the identification information being transmitted by the policy server 100, and then stores the received information into the storage region 330 (S810).

The policy agent of the wireless terminal 300 receive the policy information for blocking the network usage from the policy server 100 (S820), and then checks the applications corresponding to the identification information of the applications allowed the network usage, the identification information being pre-stored in the storage region 330, among the plurality of applications (S830).

Then, the policy agent of the wireless terminal 300 block the network connection for all applications except the applications corresponding to the identification information of the applications allowed the network usage, the identification information being pre-stored in the storage region 330, among a plurality of applications using networks based on the policy information for blocking the received network usage (S840).

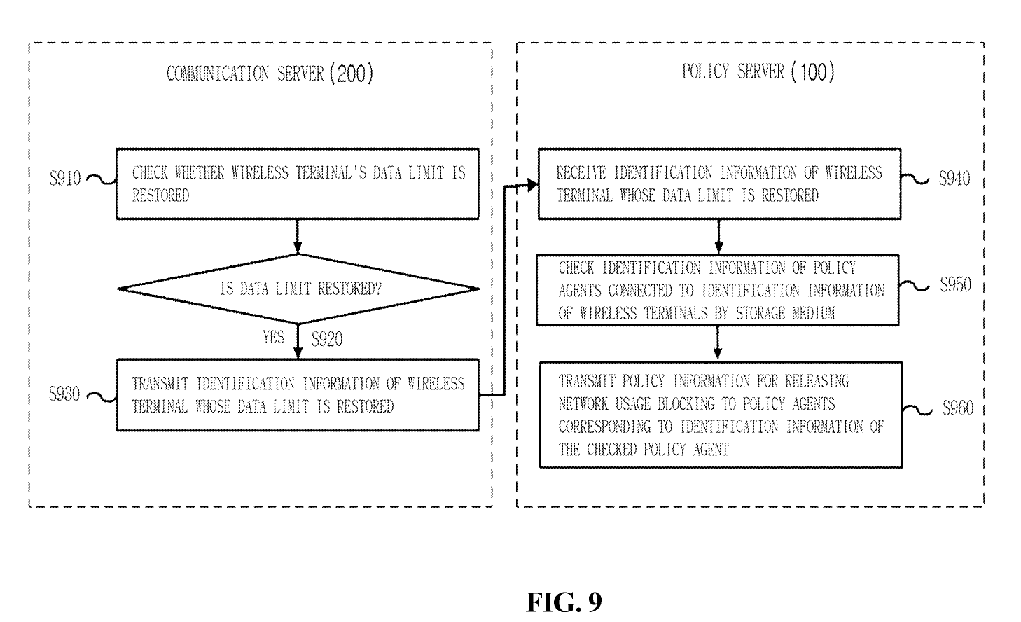

FIG. 9 shows a process releasing network connection blocking for the wireless terminal 300 whose data limit is restored according to an embodiment of the present invention.

The communication server 200 according to the present invention checks whether data limit of the wireless terminal 300 whose data limit was exceeded is restored (S910).

Whether the data limit of the wireless terminal 300 is restored may be checked by checking a restoration period of the data limit, or by checking information requesting data restoration after a subscriber of the wireless terminal 300 additively pays a data fee.

In case data limit of the wireless terminal 300 whose data limit was exceeded is restored (S920), the communication server 200 transmits identification information of the wireless terminal 300 whose data limit is restored to the policy server 100 (S930).

The policy server 100 receives the identification information of the wireless terminal 300 whose data limit is restored from the communication server 200, by using the communication section 140 (S940).

Afterwards, the checking section 150 of the policy server 100 checks identification information of the policy agent corresponding to the identification information of the wireless terminal 300 whose data limit is restored, by using the storage section 130 (S950).

Afterward, the policy server 100 processes so that the policy information for releasing the network usage blocking is transmitted to the policy agent corresponding to the identification information checked by the checking section 150, by using the processing section 160 (S960).

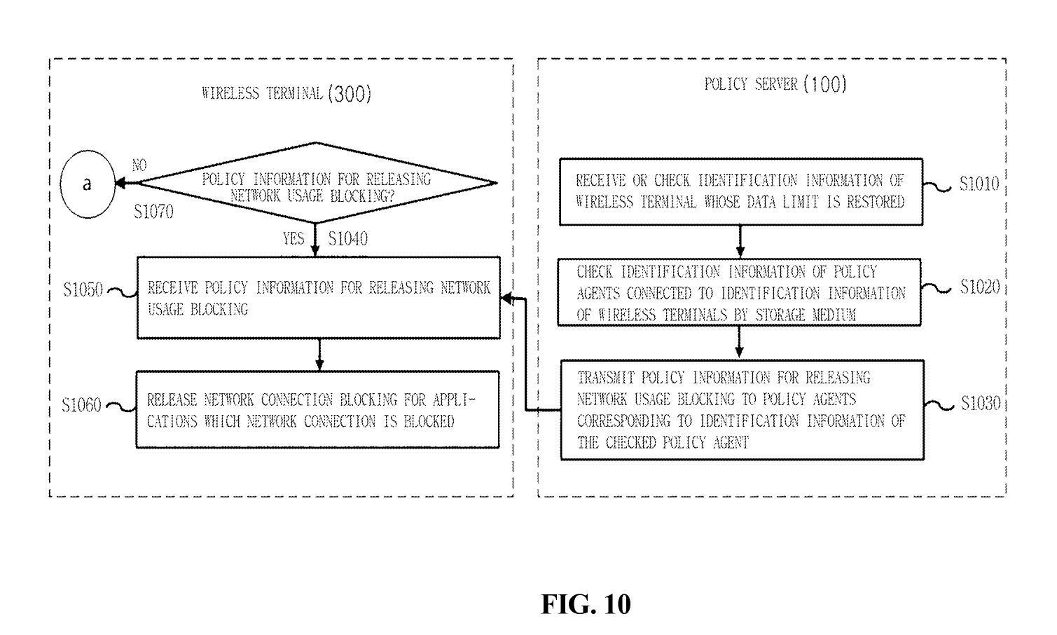

FIG. 10 shows a process releasing network connection blocking for the wireless terminal 300 whose data limit is restored by using the policy agent according to an embodiment of the present invention.

The policy server 100 in the present invention receives from the communication server or directly checks the identification information of the wireless terminal 300 whose data limit is restored (S1010).

In step S1010, whether the data limit of the wireless terminal 300 is restored may be checked in the communication 200 or the policy server 100, by checking a restoration period of the data limit for the wireless terminal 300m or by checking information for requesting data restoration after a subscriber of the wireless terminal 300 additively pays a data fee.

The policy server 100 checks the identification information of the policy agent installed in the wireless terminal 300 in response to the identification information of the user's wireless terminal 300 restoring the received or checked data limit by the storage medium (S1020).

Then, the policy server 100 transmits the policy information for releasing the network usage blocking to the policy agent corresponding to the identification information of the checked policy agent (S1030).

In case of releasing the network usage blocking by the policy information for releasing the network usage blocking (S1040), the policy agent installed in the wireless terminal 300 receive the policy information for releasing the network usage blocking transmitted from the policy server 100 (S1050), and then releases the network connection blocking for the applications based on the received policy information for releasing the network usage blocking (S1060).

A process in which the policy agent installed in the wireless terminal 300 autonomously release the network usage blocking in the step of s1070, not using the policy information for releasing the network usage blocking, is described in a following figure.

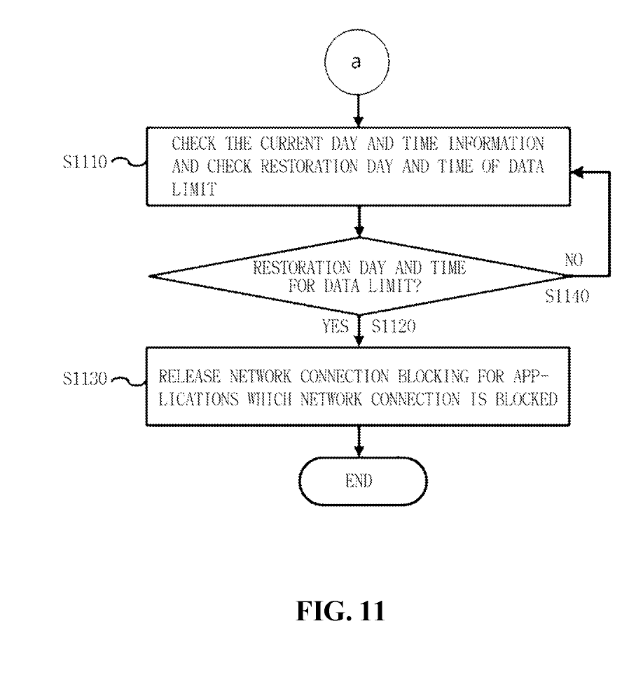

FIG. 11 shows a process releasing network connection blocking for wireless terminal 300 whose data limit is restored the policy agent according to another embodiment of the present invention.

The policy agent of the wireless terminal 300 check the current day and time information by a timer, etc. in the wireless terminal 300 in case of autonomously releasing the networking usage blocking, not using the policy information for releasing the network usage blocking (S1110).

When the current day and time information is the restoration day and time for the data limit in the step of S1110 (S1120), the policy agent of the wireless terminal 300 release the network connection blocking for the applications blocked the network connection due to the exceeding of the data limit (S1130).

When the current day and time information is not the restoration day and time for the data limit in the step of S1110 (S1140), the policy agent of the wireless terminal 300 repeats the step S1110.

1-3. (canceled)

4. A method managing a policy for reducing network load, comprising:
processing, in a policy server, so that policy information for blocking network usage is transmitted to a policy agent included in a wireless terminal whose data limit is exceeded;
blocking, in the policy agent, network connection for all applications except at least one application allowed network usage among a plurality of applications installed in the wireless terminal, according to the policy information for blocking the network usage received from the policy server;
processing, in the policy server, so that policy information for releasing the network usage blocking is transmitted to the policy agent in case the data limit of the wireless terminal is restored; and
releasing, in the policy agent, the network connection blocking for the applications, according to the policy information for releasing the network usage blocking received from the policy server.

5. The method managing a policy for reducing network load according to claim 4, further comprising:
Receiving, in the policy server, identification information of the wireless terminal whose data limit is exceeded or restored from a server over a communication network.

6. The method managing a policy for reducing network load according to claim 5, wherein the identification information of the wireless terminal includes subscriber information of the wireless terminal's user or identification information of the policy agent equipped in the wireless terminal.

7. The method managing a policy for reducing network load according to claim 5, further comprising:
transmitting, in the policy server, the policy information for blocking the network usage or the policy information for releasing the network usage blocking to the policy agent by using identification information of the policy agent corresponding to the received identification information of the wireless terminal.

8. The method managing a policy for reducing network load according to claim 7, further comprising:
storing, in the policy server, the identification information of the wireless terminal in connection with the identification the identification information of the policy agent included in the wireless terminal into a storage medium; and
checking, in the policy server, the identification information of the policy agent corresponding to the identification information of the wireless terminal whose data limit is exceeded or restored.

9. The method managing a policy for reducing network load according to claim 4, wherein the data limit is restored according to a restoration period of the data limit or additive payment of data fee.

10. The method managing a policy for reducing network load according to claim 4, wherein the policy for the network usage is restored to the previous policy before the network usage blocking according to the policy information for releasing the network usage blocking.

11. The method managing a policy for reducing network load according to claim 4, wherein the application allowed the network usage are preset to be allowed the network usage irrespective of data limit for the wireless terminal's user.

12. The method managing a policy for reducing network load according to claim 4, further comprising:
transmitting, in the policy server, identification information of the application allowed the network usage to the wireless terminal of a subscriber to a rate system with data limit.

13. The method managing a policy for reducing network load according to claim 4, wherein the policy information for blocking the network usage blocks attempt call for network connection of the applications.

14. The method managing a policy for reducing network load according to claim 4, wherein the policy information for blocking the network usage blocks background connection of the applications.

15. The method managing a policy for reducing network load according to claim 4, further comprising:
receiving, in the policy server, subscription or cancellation information of a rate system with data limit, and
wherein the network connection for the applications installed in the wireless terminal is controlled according to the received subscription or cancellation information.

16. A computer-readable recording medium for recording programs to perform a method of claim 4.

17. A system managing a policy for reducing network load, comprising:
a policy server for processing so that policy information for blocking network usage is transmitted to a policy agent included in a wireless terminal whose data limit is exceeded and policy information for releasing the network usage blocking is transmitted to the policy agent in case the data limit of the wireless terminal is restored; and
a wireless terminal for blocking network connection for all but at least one application allowed network usage among a plurality of applications installed in the wireless terminal according to the policy information for blocking the network usage received from the policy server, and releasing the network connection blocking for the applications according to the policy information for releasing the network usage blocking received from the policy server.

18. The system managing a policy for reducing network load according to claim 17, further comprising:
a communication server for providing identification information of the wireless terminal whose data limit is exceeded or restored to the policy server.

19. The system managing a policy for reducing network load according to claim 18, wherein the identification information of the wireless terminal includes subscriber information of the wireless terminal's user or identification information of the policy agent equipped in the wireless terminal.

20. The system managing a policy for reducing network load according to claim 18, wherein the policy server transmits the policy information for blocking the network usage or the policy information for releasing the network usage blocking to the policy agent by using identification information of the policy agent corresponding to the received identification information of the wireless terminal.

21. The system managing a policy for reducing network load according to claim 17, wherein the data limit of the wireless terminal is restored according to a restoration period of the data limit or additive payment of data fee.

22. The system managing a policy for reducing network load according to claim 17, wherein the policy for the network usage is restored to the previous policy before the network usage blocking according to the policy information for releasing the network usage blocking.

23. The system managing a policy for reducing network load according to claim 17, wherein the policy server receives subscription or cancellation information of a rate system with data limit, and
wherein the network connection for the applications installed in the wireless terminal is controlled according to the received subscription or cancellation information.
